(19) United States
(12) Patent Application Publication
(10) Pub. No.: US 2021/0270678 A1
(43) Pub. Date: Sep. 2, 2021

(54) PAIRED BASE UNIT AND RECEIVER FOR LONG-RANGE, WIRELESS MONITORING OF THERMOMETER TEMPERATURES

(71) Applicant: ThermoWorks Inc., American Fork, UT (US)

(72) Inventor: Kevin Owen, Saratoga Springs, UT (US)

(21) Appl. No.: 17/189,018

(22) Filed: Mar. 1, 2021

Related U.S. Application Data
(60) Provisional application No. 62/983,439, filed on Feb. 28, 2020.

(51) Int. Cl. G01K 1/024; G08C 17/02

(52) U.S. Cl. CPC G01K 1/024; G08C 17/02

(57) ABSTRACT

A system for monitoring thermometer temperatures may include a base unit and one or more receivers. The base unit may determine temperatures associated with one or more probes. The base unit may transmit the determined temperatures wirelessly to the one or more receivers without use of an intermediary device (such as a bridge, gateway, router, hub, or relay device) or network. The base unit may transmit data to the one or more receivers using a long-rage (LoRa) transmitter or transceiver. The base unit may be paired to the one or more receivers such that the one or more receivers receive transmissions from the base unit but not a second base unit that may be operating in the transmission range of the one or more receivers. The base unit may transmit data to the one or more receivers at a particular transmission interval.

### BACKGROUND OF THE INVENTION

Barbecue (BBQ) is a cooking method that may involve cooking, smoking, grilling, or roasting meat (or other food items) using wood, charcoal, or gas. Temperatures—such as the internal temperature of the meat and the temperature of the cooking area or space may be helpful—play an important role in barbecue cooking. Knowing the internal temperature of the meat helps a chef avoid taking the meat off the grill too early (leaving it underdone and potentially unsafe for consumption) or too late (resulting in overdone meat that is tough or dry). It may be desirable to cook meat at a particular temperature in order to achieve a desired texture or consistency in the meat. Thus, knowing the internal temperature of the cooking space may allow a chef (or a computer) to adjust the heating element to achieve the particular temperature.

A chef may use a thermometer to determine the internal temperature of the meat and the temperature of the cooking surface or space (such as the temperature of the inside of a smoker or a grill). Some thermometers require that a chef manually insert the thermometer into the meat each time the chef wants to know the temperature of the meat. Such a thermometer may not function if left inserted in the meat and exposed to the high temperatures of the grill or smoker. Other thermometers utilize a probe that is inserted into and left in the meat and carries temperature data to a base unit that resides away from the cooking area. The base unit may determine and display a temperature associated with the probe. The base unit allows the user to see the temperature of the meat without having to repeatedly insert and remove the thermometer from the meat. Being able to monitor temperatures more easily may improve the resulting barbecue product.

### BRIEF DESCRIPTION OF THE DRAWINGS

In order to describe the manner in which the features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 illustrates an example system, including a base unit and a receiver, for monitoring temperatures of up to two probes.

FIG. 2 illustrates an example system, including a base unit and a receiver, for monitoring temperatures of up to four probes.

FIG. 3 illustrates an example of two base units and five receivers operating in close proximity without interference.

### DETAILED DESCRIPTION OF THE INVENTION

The present disclosure concerns a system for monitoring thermometer temperatures. The system may be used to monitor thermometer temperatures associated with barbecuing, such as the internal temperatures of meat and the temperatures of a cooking surface, area, or space.

The system may include a base unit and a receiver. Both the base unit and the receiver may operate using battery power. The base unit may include one or more probes for obtaining temperature data. The one or more probes may obtain temperature data from an item (such as a piece of meat cooking on a grill) or from a location (such as the inside of a barbecue). The base unit may determine temperatures associated with the one or more probes.

The base unit may share the determined temperatures wirelessly with the receiver. The base unit may share the determined temperatures directly with the receiver without use of an intermediary device (such as a bridge, gateway, router, hub, or relay device) or network (such as a cellular or Wi-Fi network). The base unit may transmit data to the receiver over a long distance. For example, typical radio-frequency modules may have a transmission range of up to approximately 300-500 ft. The base unit, in contrast, may transmit data more than one mile (including approximately 1.24 miles in distance). The base unit may also transmit data with greater transmission strength than traditional radio-frequency modules. Thus, the receiver may still receive transmissions from the base unit even when obstacles (such as walls) exist between the base unit and the receiver.

Multiple receivers and base units may operate in close proximity without interference with each other. A receiver may operate within range of multiple base units that are all transmitting temperature data. But the receiver may receive data from only one base unit. For example, the base unit may transmit signals on a particular sub-channel not used by the other base units. The receiver may listen for signals on only the particular sub-channel. Even though a receiver may receive signals from only one base unit, multiple receivers may receive signals from the one base unit. For example, multiple receivers may listen for signals from the one base unit on the particular sub-channel. In this way, multiple individuals not located near each other can all monitor temperatures associated with the one base unit without having to use additional devices to communicate with each other.

The system described provides features and functionality useful for monitoring thermometer temperatures and in particular food and cooking space temperatures. First, a user can monitor temperatures without being present at a location of the base unit. For example, a user can monitor temperatures for a base unit associated with a backyard grill while going inside of the house. When cooking times are long, this functionality makes the cooking process significantly more convenient for the user. Second, being able to track temperatures over long distances and through obstacles provides the user greater flexibility in temperature monitoring. For example, the user can monitor temperatures for a base unit associated with a backyard grill not only while going inside the user's house but also while going to a house down the street to watch a sporting event or to a nearby park to enjoy outdoor activities. Third, monitoring temperatures with a receiver without relying on a third device or separate network increases reliability, reduces costs, simplifies system set up and maintenance, and increases the environments in which the system can be used. For example, an alternative system may allow a user to remotely monitor temperatures for a home grill using an app on a smartphone. But the alternative system may rely on multiple devices (e.g., the smartphone and a wireless router) and networks (the home internet connection and the cellular connection for the phone). A failure in any of those devices or networks may cause the alternative system to fail. The home internet connection and the cellular connection may have associated set up and maintenance costs (such as monthly fees). Moreover, such a system may not function where the required networks are not accessible (such as at a campsite) or there is insufficient external power for the required networks. Fourth, multiple receivers and base units can be used in close proximity without interfering with each other. For example, a user can use multiple base units to monitor multiple grills. The user can monitor each of the base units using a separate receiver and have all the receivers in a single location without signals from the multiple base units interfering with each other. Fifth, multiple people can monitor temperatures from a single base unit. Sixth, the system relies only on battery power and can be used where external power sources are not available.

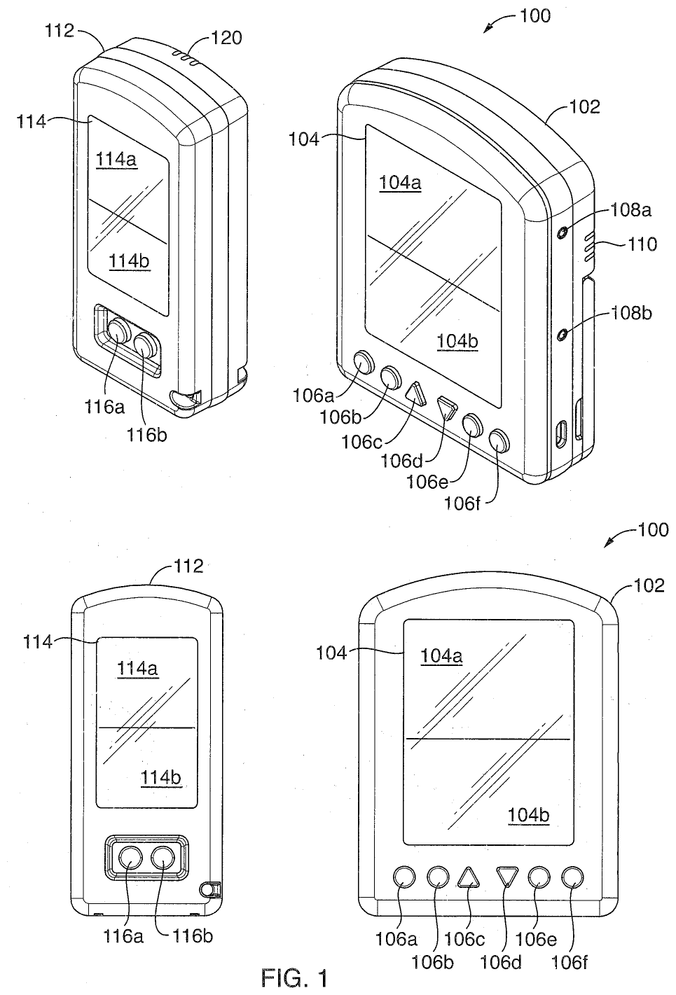

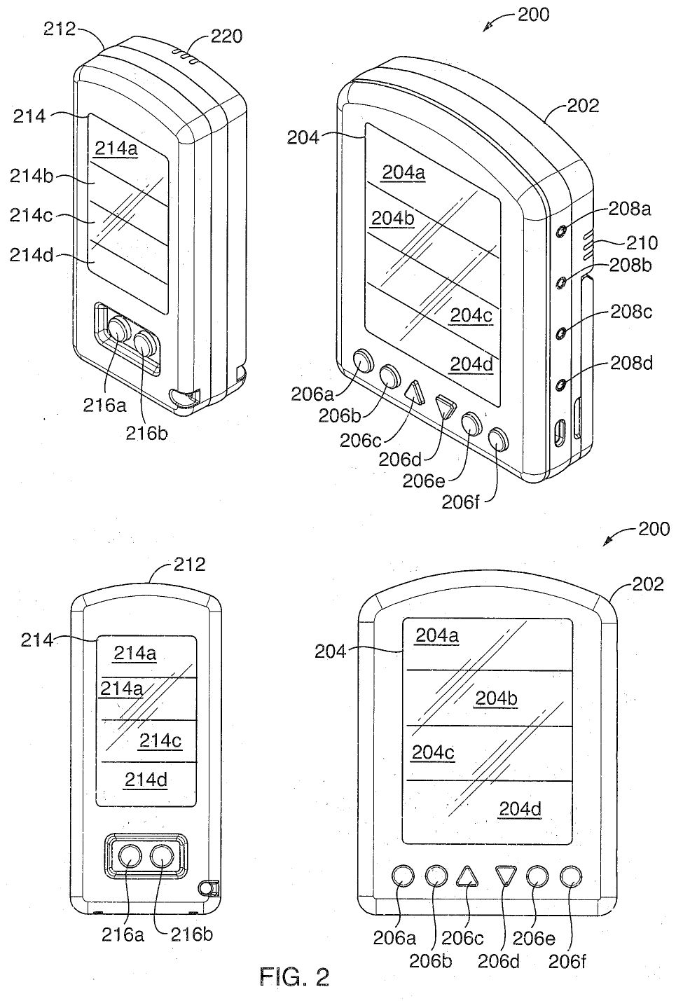

FIGS. 1 and 2 illustrate example systems 100, 200 for monitoring thermometer readings. The system 100 may include a base unit 102 and a receiver 112. The system 200 may include a base unit 202 and a receiver 212. The base unit 102 and the base unit 202 may be identical except where differences are specifically described. Similarly, the receiver 112 and the receiver 212 may be identical except where differences are specifically described.

The base units 102, 202 may determine a temperature for each of one or more probes. Each of the one or more probes may obtain temperature data from an item (such as a piece of meat cooking on a grill) or a location (such as the inside of a grill). The temperature associated with each of the one or more probes may change over time. The base units 102, 202 may continuously determine the temperature associated with each of the one or more probes. The base units 102, 202 may display the temperatures associated with each of the one or more probes and may change the display as the temperatures associated with each of the one or more probes changes. The base unit 102 may determine and monitor temperatures associated with up to two probes. The base unit 202 may determine and monitor temperatures associated with up to four probes. Other base units may determine and monitor temperatures associated with other numbers of probes.

The base units 102, 202 may each include a wireless communication system. The wireless communication system may include one or more hardware and software components. The wireless communication system may transmit data wirelessly. The data may include temperatures associated with the one or more probes, information related to the temperatures, information about the base units 102, 202 or settings of the base units 102, 202, and authentication information. Signals transmitted from the base units 102, 202 may include unique codes associated with the base units 102, 202. One or more receivers (such as the receivers 112, 212) may receive the transmitted data. The wireless communication system also may receive data transmitted wirelessly. For example, the wireless communication system may receive data transmitted by one or more receivers (such as the receivers 112, 212). The wireless communication system may include hardware capable of transmitting and receiving data across a defined bandwidth. The wireless communication system may be designed to transmit and receive data on a particular channel or particular sub-channel of the defined bandwidth.

The wireless communication system may transmit data over long distances. For example, the wireless communication system may transmit data 1.24 miles. The wireless communication system may transmit signals strong enough to persist through obstacles such as walls, cement, glass, dirt, etc. The wireless communication system may transmit data across long distances and through obstacles while using a low amount of power. For example, the wireless communication system may operate using a battery without relying on an external power source. The wireless communication system may include a long-range (LoRa) device, such as a LoRa transmitter, receiver, or transceiver.

The base units 102, 202 may use the wireless communication system to pair with one or more receivers (such as the receivers 112, 212). A user may pair the base unit 102 and the receiver 112 without use of any additional devices or networks. In other words, the functionality for pairing the base unit 102 and the receiver 112 may be contained entirely in the base unit 102 and the receiver 112. It may be that pairing the base unit 102 and the receiver 112 requires that both the base unit 102 and the receiver 112 enter a pairing mode. When paired, the base unit 102 and the receiver 112 may communicate directly with each other (such as through point-to-point communication). Communicating directly may include the base unit 102 transmitting a signal to the receiver 112 and the receiver 112 receiving the signal without either the base unit 102 or the receiver 112 relying on an additional or intermediary device (such as a gateway, router, switch, hub, or bridge) or intermediary network (such as a cellular network) to relay the signal. It may be that the receivers 112, 212 can be paired with only a single base unit. The base units 102, 202 may, however, be paired with multiple receivers. Thus, a single transmission from the base unit 102 may be received by multiple receivers.

When paired, the base unit 102 and the receiver 112 may communicate directly with each other without interference from neighboring base units or receivers. For example, assume the receiver 112 is within transmission range of the base unit 102 and is also within transmission range of a second base unit. Assume the base unit 102 transmits a first signal and the second base unit transmits a second signal. When the receiver 112 is paired with the base unit 102, the receiver 112 may receive the first signal from the base unit 102 but not the second signal from the second base unit. Similarly, the receiver 112 may transmit a signal to the base unit 102 without interfering with transmissions intended for the second base unit.

When the receiver 112 is not paired with the base unit 102, the receiver 112 may not receive signals transmitted by the base unit 102. For example, the receiver 112 may not listen for signals unless the receiver 112 is paired with a base unit (such as the base unit 102) or the receiver 112 is in a pairing mode. Similarly, the base unit 102 may not listen for signals unless the base unit 102 is paired with a receiver (such as the receiver 112) or is in a pairing mode.

A base unit (such as the base units 102, 202) may be paired with a receiver (such as the receivers 112, 212) when they are manufactured or at the time of packaging or sale. The base unit and the receiver may also allow a user to modify the pairing. For example, in a situation where the base unit 102 and the receiver 112 are not paired at the time of purchase, the user may pair the base unit 102 and the receiver 112. As another example, in a situation where the base unit 102 and the receiver 112 are paired at the time of purchase, the user may disconnect the pairing between the base unit 102 and the receiver 112. The user may then pair the receiver 112 with a different base unit. The user may also pair the base unit 102 with a different receiver. As another example, in a situation where the base unit 102 and the receiver 112 are paired at the time of purchase, the user may keep the pairing between the base unit 102 and the receiver 112 and also pair the base unit 102 with a second receiver.

The wireless communication system of the base units 102, 202 may include a communications control module. The communications control module may control operation of the wireless communication system. The communications control module may cause the wireless communication system to transmit data on a particular channel or a particular sub-channel of the defined bandwidth. The particular channel or the particular sub-channel may be assigned to the base units 102, 202 at the time of manufacture or sale. A user may not be able to modify the particular channel or the particular sub-channel assigned to the base units 102, 202. The communications control module of the base unit 102 may be designed to allow the wireless communication system to transmit signals on only the particular channel or the particular sub-channel of the defined bandwidth. Pairing the receiver 112 with the base unit 102 may include the receiver 112 learning, from the base unit 102, the particular channel or the particular sub-channel on which the base unit 102 transmits signals. The receiver 112 and the base unit 102 may have a pairing mode in which the receiver 112 learns the particular channel or the particular sub-channel on which the base unit 102 transmits signals. Pairing the receiver 112 with the base unit 102 may include configuring the receiver 112 to send and receive signals using only the particular channel or the particular sub-channel. Pairing the receiver 112 with the base unit 102 may include configuring the receiver 112 to listen for signals from the base unit 102 on only the particular channel or the particular sub-channel

Devices that have not been paired with the base units 102, 202 may not be able to receive or understand signals transmitted by the base units 102, 202.

Pairing the receiver 112 with the base unit 102 may include the receiver 112 providing authentication information to the base unit 102. Similarly, pairing the receiver 112 with the base unit 102 may include the base unit 102 providing authentication information to the receiver 112. The receiver 112 and the base unit 102 may include a pairing mode in which the receiver 112 may provide authentication information to the base unit 102 and the base unit 102 may provide authentication information to the receiver 112. The base unit 102 may not pair with the receiver 112 if the receiver 112 does not provide the base unit 102 with valid authentication information. The receiver 112 may not pair with the base unit 102 if the base unit 102 does not provide valid authentication information to the receiver 112. The receiver 112 may not be able to understand data transmitted by the base unit 102 if the receiver 112 does not provide valid authentication information to the base unit 102 and receive information from the base unit 102 regarding how to understand signals sent from the base unit 102.

The communications control module of the base units 102, 202 may cause the wireless communication system of the base units 102, 202 to transmit signals at a particular transmission interval. The communications control module may cause the wireless communication system to transmit signals with a particular transmission size. The particular transmission interval may be set at the time of manufacture or sale. The particular transmission interval may be fixed or variable. The particular transmission interval may be chosen based on balancing two or more factors such as transmission distance, power consumption, and transmission size. For example, a transmission interval of more than 10 to 15 seconds but less than 15 minutes to an hour may be used when the base units 102, 202 are used to monitor temperatures associated with cooking food items. In particular, a transmission interval of thirty seconds may provide a desired balance for monitoring temperatures associated with cooking food items.

The base units 102, 202 may include display screens 104, 204, user input devices 106a-f, 206a-f, probe inputs 108a-b, 208a-d, and speakers 110, 210.

The probe inputs 108a-b, 208a-d may be openings in the base units 102, 202 for connecting the base units 102, 202 to the one or more probes. The one or more probes may have a connector end and a probe end. A wire may connect the connector end to the probe end. The connector end may fit into the probe inputs 108a-b, 208a-d. The probe end may be designed for inserting into an item or for placing in an area. The probe may be designed to conduct thermal energy from the item to the base units 102, 202. The probe end may be made of metal and have a pointed tip. The base units 102, 202 may determine a temperature associated with each of the one or more probes based on data obtained from the one or more probes and transmitted to the base units 102, 202 through the probe inputs 108a-b, 208a-d. The base unit 102 may be able to connect to two probes while the base unit 202 may be able to connect to four probes.

The display screens 104, 204 may display one or more temperatures associated with the one or more probes. The display screens 104, 204 may display information related to the one or more temperatures. For example, the display screen 104 may display a first high trigger temperature associated with a first probe (which may be connected to the base unit 102 using the probe input 108a), a first low trigger temperature associated with the first probe, a second high trigger temperature associated with a second probe (which may be connected to the base unit 102 using the probe input 108b), and a second low trigger temperature associated with the second probe. The base unit 102 may have a setting such that when the first temperature reaches the first high trigger temperature (or the first low trigger temperature), the base unit 102 provides a first alert. Similarly, when the second temperature reaches the second high trigger temperature (or the second low trigger temperature), the base unit 102 may provide a second alert. The first alert may be different from the second alert.

The display screen 104 may be divided into a first part 104a and a second part 104b. The first part 104a may display information associated with a first probe connected to the base unit 102 using the probe input 108a. The second part 104b may display information associated with a second probe connected to the base unit 102 using the probe input 108b. The display screen 204 may be divided into a first part 204a, a second part 204b, a third part 204c, and a fourth part 204d. The first part 204a may display information associated with a first probe connected to the base unit 202 using the probe input 208a. The second part 204b may display information associated with a second probe connected to the base unit 202 using the probe input 208b. The third part 204c may display information associated with a third probe connected to the base unit 202 using the probe input 208c. The fourth part 204d may display information associated with a fourth probe connected to the base unit 202 using the probe input 208d.

The user input devices 106a-f, 206a-f may allow a user of the base units 102, 202 to provide input information to the base units 102, 202. In some designs. the user input devices 106a-f, 206a-f may be physical buttons. The user input devices 106a-f, 206a-f may allow the user to interact with information displayed on the display screens 104, 204. The user input devices 106a-f, 206a-f may allow the user to change settings of the base units 102, 202. The user input devices 106a-f, 206a-f may allow the user to change what is displayed on the display screens 104, 204. The user input devices 106a-f, 206a-f may allow a user to cause the base units 102, 202 to enter a pairing mode for pairing the base units 102, 202 with a receiver (such as the receivers 112, 212).

The speakers 110, 210 may produce one or more sounds. The base units 102, 202 may use the speakers 110, 210 to produce one or more sounds when a temperature being monitored by the base units 102, 202 reaches a trigger temperature. The base units 102, 202 may use the speakers 110, 210 to provide the first alert or the second alert.

The receivers 112, 212 may receive wireless communications from the base units 102, 202. For example, the receiver 112 may receive, from the base unit 102, a temperature associated with a probe connected to the base unit 102. The receivers 112, 212 may also transmit information to the base units 102, 202. For example, a user may set or change a trigger temperature on the receiver 112. The receiver 112 may communicate the trigger temperature to the base unit 102. The base unit 102 may update a trigger temperature stored on the base unit 102 based on the information received from the receiver 112. As another example, a user may change a type of alert associated with a trigger temperature on the receiver 112. The receiver 112 may communicate the change to the base unit 102. The base unit 102 may update a type of alert associated with a trigger temperature based on the information received from the receiver 112.

The receivers 112, 212 may include a wireless communication system. The wireless communication system may include one or more hardware and software components. The wireless communication system and the communications control module of the receivers 112, 212 may include the features and functions described in connection with the wireless communication system and the communications control module of the base units 102, 202. The receivers 112, 212 may use the wireless communication system to pair with a base unit (such as the base units 102, 202). When pairing with a base unit, the receivers 112, 212 may learn, from the base unit, a particular channel or a particular sub-channel on which the base unit transmits signals. Once paired, the receivers 112, 212 may send and receive signals only on the particular channel or the particular sub-channel The receivers 112, 212 may listen for signals from the base unit only on the particular channel or the particular sub-channel. The communications control module may cause the wireless communication system of the receivers 112, 212 to transmit and receive signals at a particular transmission interval. The base unit may provide the particular transmission interval to the receivers 112, 212.

The receivers 112, 212 may include display screens 114, 214, user input devices 116a-b, 216a-b, and speakers 120, 220.

The display screens 114, 214 may display information received from the base units 102, 202. The display screens 114, 214 may display information associated with settings of the receivers 112, 212. The display screen 114 may be divided into a first part 114a and a second part 114b. The first part 114a may display information associated with a first probe connected to the base unit 102 using the probe input 108a. For example, the first part 114a may display a first temperature associated with the first probe, a high trigger temperature associated with the first probe, and a low trigger temperature associated with the first probe. The second part 114b may display information associated with a second probe connected to the base unit 102 using the probe input 108b. The display screen 204 may be divided into a first part 214a, a second part 214b, a third part 214c, and a fourth part 214d. The first part 214a may display information associated with a first probe connected to the base unit 202 using the probe input 208a. The second part 214b may display information associated with a second probe connected to the base unit 202 using the probe input 208b. The third part 214c may display information associated with a third probe connected to the base unit 202 using the probe input 208c. The fourth part 214d may display information associated with a fourth probe connected to the base unit 202 using the probe input 208d.

The user input devices 116a-b, 216a-b may allow a user of the receivers 112, 212 to provide input information to the receivers 112, 212. In some designs, the user input devices 116a-b, 216a-b may be physical buttons. The user input devices 116a-b, 216a-b may allow the user to change settings of the receivers 112, 212. The user input devices 116a-b, 216a-b may allow the user to change what is displayed on the display screens 114, 214. The user input devices 116a-b, 216a-b may allow a user to cause the receivers 112, 212 to enter a pairing mode for pairing the receivers 112, 212 with a base unit (such as the base units 102, 202).

The speakers 120, 220 may produce one or more sounds. The receivers 112, 212 may use the speakers 120, 220 to produce one or more sounds when a temperature reaches a trigger temperature. The receivers 112, 212 may use the speakers 120, 220 to provide the first alert or the second alert. The receivers 112, 212 and the base units 102, 202 may have settings that control whether the receivers 112, 212, the base units 102, 202, or both provide alerts using the speakers 110, 210, 120, 220.

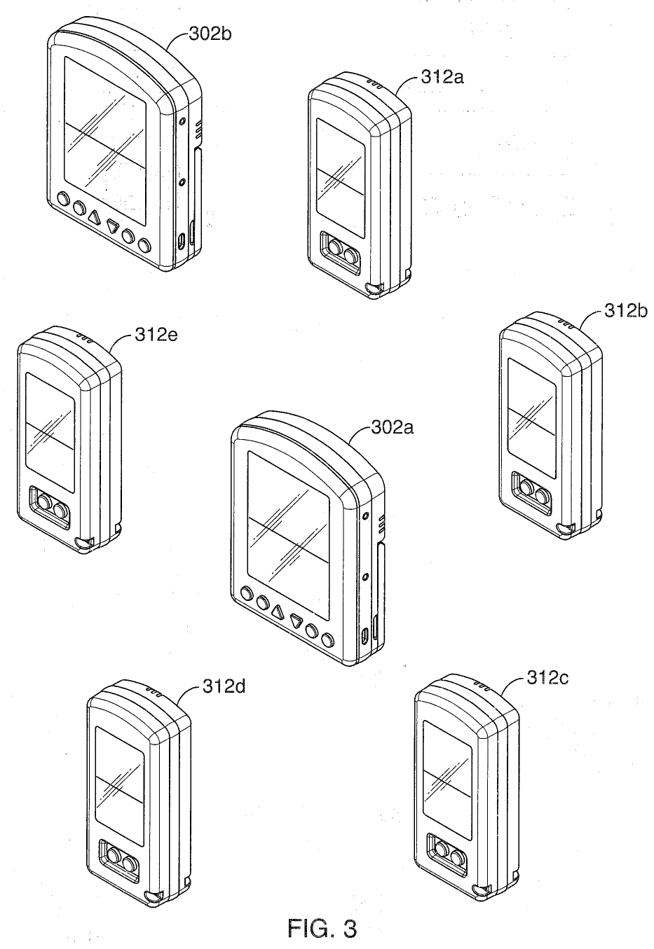

FIG. 3 illustrates an example of base units 302a-b and receivers 312a-e operating in proximity of one another without experiencing interference. The base units 302a, 302b may be monitoring one or more temperatures. The receivers 312a-e may be located within a transmission range of both the base unit 302a and the base unit 302b.

Assume the base units 302a, 302b are initially not paired with any of the receivers 312a-e. The base units 302a, 302b may not transmit temperature data when the base units 302a, 302b are not paired with a receiver.

Assume the base unit 302a is then paired with the receiver 312a. Assume the base unit 302a begins transmitting first temperature data at a particular transmission interval on a first sub-channel. The receiver 312a may receive the first temperature data on the first sub-channel at the particular transmission interval. The receivers 312b-e may not, however, receive the first temperature data. The receivers 312b-e may not listen for temperature data because they are not paired with a base unit.

Assume the base unit 302b is then paired with the receiver 312b. Assume the base unit 302b begins transmitting second temperature data at the particular transmission interval on a second sub-channel. The first sub-channel may be different from the second sub-channel. The receivers 312a-e may be designed such that the receivers 312a-e can distinguish between transmissions sent on the first sub-channel and the second sub-channel. The receiver 312b may receive the second temperature data on the second sub channel at the particular transmission interval. The receiver 312a may not, however, receive the second temperature data but may continue to receive the first temperature data without interference.

Assume the base unit 302a is then paired with the receiver 312d, and the base unit 302b is then paired with the receivers 312c, 312e. The receivers 312a, 312d may receive the first temperature data but not the second temperature data. The receivers 312b, 312c, 312e may receive the second temperature data but not the first temperature data. The transmission of the first temperature data by the base unit 302a may not interfere with the receivers 312b, 312c, 312e receiving the second temperature data. The transmission of the second temperature data by the base unit 302b may not interfere with the receivers 312a, 312d receiving the first data.

The base unit 302a may transmit the first temperature data to the receivers 312a, 312d without use of an intermediary device or network. Similarly, the base unit 302b may transmit the second temperature data to the receivers 312b, 312c, 312e without use of an intermediary device or network.

What is claimed is:

1. A system for monitoring thermometer temperatures comprising a base unit and at least one receiver, the base unit comprising at least one probe for obtaining temperature data from a food item, the base unit being configured to determine temperatures associated with the at least one probe and the base unit being configured to share the temperatures wirelessly with the at least one receiver, the base unit being further configured to share temperatures directly with the at least one receiver without the use of an intermediary device.

2. The system of claim 1, wherein the at least one probe is configured to obtain temperature data from a location.

3. The system of claim 1, wherein the base unit is configured to transmit data over a distance greater than one mile.

4. The system of claim 1, the base unit being configured to continuously determine the temperature associated with each of the at least one probe.

5. The system of claim 1, the at least one probe comprising two probes.

6. The system of claim 1, the at least one probe comprising four probes.

7. The system of claim 1, the intermediary device comprising at least one of a bridge, gateway, router, hub or relay device.

8. The system of claim 1, wherein the base unit is configured to share temperatures directly with the at least one receiver without the use of a network.

9. The system of claim 1, wherein the base unit is configured to transmit data with greater transmission strength than radio-frequency modules.

10. The system of claim 1, wherein the at least one receiver is configured to receive transmissions from the base unit even when physical obstacles are located between the base unit and the receiver.

11. The system of claim 1, further comprising at least two base units, wherein a single receiver operating in range of the at least two base units only receives data from one of the at least two base units.

12. A system for monitoring thermometer temperatures comprising a base unit and at least one receiver, the base unit comprising at least one probe for obtaining temperature data from a location, the base unit being configured to determine temperatures associated with the at least one probe and the base unit being configured to share the temperatures wirelessly with the at least one receiver, the base unit being further configured to share temperatures directly with the at least one receiver without the use of an intermediary device.
